(19) United States
(12) Patent Application Publication
(10) Pub. No.: US 2025/0311023 A1
(43) Pub. Date: Oct. 2, 2025

(54) INFORMATION SENDING METHOD AND APPARATUS, INFORMATION RECEIVING METHOD AND APPARATUS, TERMINAL, AND NETWORK SIDE DEVICE

(71) Applicant: VIVO MOBILE COMMUNICATION CO., LTD., Dongguan (CN)

(72) Inventor: Sihan CHENG, Dongguan (CN)

(73) Assignee: VIVO MOBILE COMMUNICATION CO., LTD., Dongguan (CN)

(21) Appl. No.: 19/227,451

(22) Filed: Jun. 3, 2025

Related U.S. Application Data
(63) Continuation of application No. PCT/CN2023/135258, filed on Nov. 30, 2023.

(30) Foreign Application Priority Data
Dec. 7, 2022 (CN) 202211567691.4

(51) Int. Cl. H04W 76/10; H04W 8/22; H04W 60/04

(52) U.S. Cl. CPC H04W 76/10; H04W 8/22; H04W 60/04

(57) ABSTRACT

This application discloses an information sending method and apparatus, an information receiving method and apparatus, a terminal, and a network side device. The information sending method includes: A terminal sends first indication information to a network side device, where the first indication information is used to request an address of a server, the first indication information is carried in a first message, and the first message is used for at least one of the following: establishing a protocol data unit (PDU) session; modifying the PDU session; or registration.

### CROSS-REFERENCE TO RELATED APPLICATIONS

This application is a continuation of International Application No. PCT/CN2023/135258, filed Nov. 30, 2023, which claims priority to Chinese Patent Application No. 202211567691.4, filed Dec. 7, 2022. The entire contents of each of the above-referenced applications are expressly incorporated herein by reference.

### TECHNICAL FIELD

This application belongs to the field of communication technologies, and in particular, relates to an information sending method and apparatus, an information receiving method and apparatus, a terminal, and a network side device.

### BACKGROUND

Currently, a terminal obtains, by using configuration information pre-configured in the terminal, an address of a server that provides a service for the terminal, and therefore, the terminal can obtain only a fixed server address. Consequently, flexibility of obtaining, by the terminal, the address of the server that provides a service for the terminal is relatively poor.

### SUMMARY

Embodiments of this application provide an information sending method and apparatus, an information receiving method and apparatus, a terminal, and a network side device.

According to a first aspect, an information sending method is provided, including:
sending, by a terminal, first indication information to a network side device, where the first indication information is used to request an address of a server; where
the first indication information is carried in a first message, and the first message is used for at least one of the following:
establishing a protocol data unit PDU session;
modifying the PDU session; or
registration.

According to a second aspect, an information receiving method is provided, including:
receiving, by a network side device, first indication information sent by a terminal, where the first indication information is used to request an address of a server; where
the first indication information is carried in a first message, and the first message is used for at least one of the following:
establishing a protocol data unit PDU session;
modifying the PDU session; or
registration.

According to a third aspect, an information sending apparatus is provided, where a terminal includes the information sending apparatus, and the apparatus includes:
a sending module, configured to send first indication information to a network side device, where the first indication information is used to request an address of a server; where
the first indication information is carried in a first message, and the first message is used for at least one of the following:
establishing a protocol data unit PDU session;
modifying the PDU session; or
registration.

According to a fourth aspect, an information receiving apparatus is provided, where a network side device includes the information receiving apparatus, and the apparatus includes:
a receiving module, configured to receive first indication information sent by a terminal, where the first indication information is used to request an address of a server; where
the first indication information is carried in a first message, and the first message is used for at least one of the following:
establishing a protocol data unit PDU session;
modifying the PDU session; or
registration.

According to a fifth aspect, a terminal is provided. The terminal includes a processor and a memory, the memory stores a program or instructions capable of being run on the processor, and when the program or the instructions are executed by the processor, the steps of the method according to the first aspect are implemented.

According to a sixth aspect, a terminal is provided, including a processor and a communication interface. The communication interface is configured to send first indication information to a network side device, where the first indication information is used to request an address of a server, the first indication information is carried in a first message, and the first message is used for at least one of the following: establishing a protocol data unit PDU session; modifying the PDU session; or registration.

According to a seventh aspect, a network side device is provided. The network side device includes a processor and a memory, and the memory stores a program or instructions executable on the processor. When the program or the instructions are executed by the processor, the steps of the method according to the second aspect are implemented.

According to an eighth aspect, a network side device is provided, including a processor and a communication interface. The communication interface is configured to receive first indication information sent by a terminal, where the first indication information is used to request an address of a server, the first indication information is carried in a first message, and the first message is used for at least one of the following: establishing a protocol data unit PDU session; modifying the PDU session; or registration.

According to a ninth aspect, an information receiving/sending system is provided, including a terminal and a network side device. The terminal may be configured to perform the steps of the information sending method according to the first aspect, and the network side device may be configured to perform the steps of the information receiving method according to the second aspect.

According to a tenth aspect, a readable storage medium is provided. The readable storage medium stores a program or instructions, and when the program or the instructions are executed by a processor, the steps of the method according to the first aspect are implemented, or the steps of the method according to the second aspect are implemented.

According to an eleventh aspect, a chip is provided. The chip includes a processor and a communication interface, the communication interface is coupled to the processor, and the processor is configured to run a program or instructions to implement the method according to the first aspect or the method according to the second aspect.

According to a twelfth aspect, a computer program product/program product is provided. The computer program product/program product is stored in a storage medium, and the computer program/program product is executed by at least one processor to implement the steps of the method according to the first aspect or the steps of the method according to the second aspect.

In the embodiments of this application, a terminal sends first indication information to a network side device, where the first indication information is used to request an address of the server, the first indication information is carried in a first message, and the first message is used for at least one of the following: establishing a protocol data unit PDU session; modifying the PDU session; or registration. In this way, the address of the server is requested by using the first indication information carried in the first message, so that flexibility of obtaining, by the terminal, the address of the server that provides a service for the terminal can be improved.

### BRIEF DESCRIPTION OF DRAWINGS

FIG. 1 is a block diagram of a wireless communication system to which embodiments of this application are applicable;

FIG. 2 is a schematic diagram of an AI-based communication network optimization procedure according to an embodiment of this application;

FIG. 3 is a first schematic diagram of a PDU session establishment procedure according to an embodiment of this application;

FIG. 4 is a flowchart of an information sending method according to an embodiment of this application;

FIG. 5 is a flowchart of an information receiving method according to an embodiment of this application;

FIG. 6 is a schematic diagram of a 5G system registration procedure according to an embodiment of this application;

FIG. 7 is a second schematic flowchart of PDU session establishment according to an embodiment of this application;

FIG. 8 is a schematic diagram of a PDU session modification procedure according to an embodiment of this application;

FIG. 9 is a structural diagram of an information sending apparatus according to an embodiment of this application;

FIG. 10 is a structural diagram of an information receiving apparatus according to an embodiment of this application;

FIG. 11 is a structural diagram of a communication device according to an embodiment of this application;

FIG. 12 is a schematic diagram of a structure of a terminal according to an embodiment of this application; and

FIG. 13 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects. The term “indication” in the specification and claims of this application may be an explicit indication, or may be an implicit indication. An explicit indication may be understood as: A sender explicitly notifies, in a sent indication, an operation that needs to be performed by a receiver or a request result. An implicit indication may be understood as: A receiver performs determining based on an indication sent by a sender, and determines, based on a determining result, an operation that needs to be performed or a request result.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

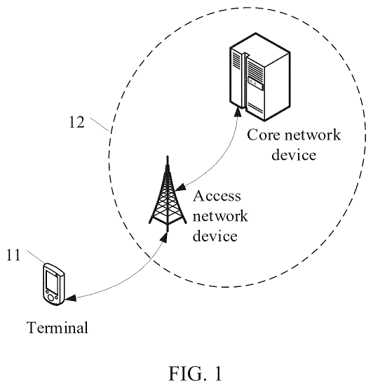

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer that is also referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle-mounted user equipment (VUE), pedestrian user equipment (PUE), a smart home device (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. In addition to the foregoing terminal devices, the terminal device may be a chip in a terminal, such as a modem chip or a System on Chip (SoC). It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a WiFi node, and the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another proper term in the art. The base station is not limited to a specific technical vocabulary provided that a same technical effect is achieved. It should be noted that in the embodiments of this application, a base station in an NR system is merely used as an example for description, but does not limit a specific type of the base station. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a policy and charging rules function unit (PCRF), an Edge Application Server Discovery Function (EASDF), Unified Data Management (UDM), Unified Data Repository (UDR), a Home Subscriber Server (HSS), Centralized network configuration (CNC), a Network Repository Function (NRF), a Network Exposure Function (NEF), a local NEF (Local NEF or L-NEF), a Binding Support Function (BSF), an Application Function (AF), or the like. It should be noted that, in the embodiments of this application, only a core network device in an NR system is used as an example for description, and a specific type of the core network device is not limited.

To better understand the embodiments of the present application, the following technical points are first described:

### 1. AI+ Communication Network

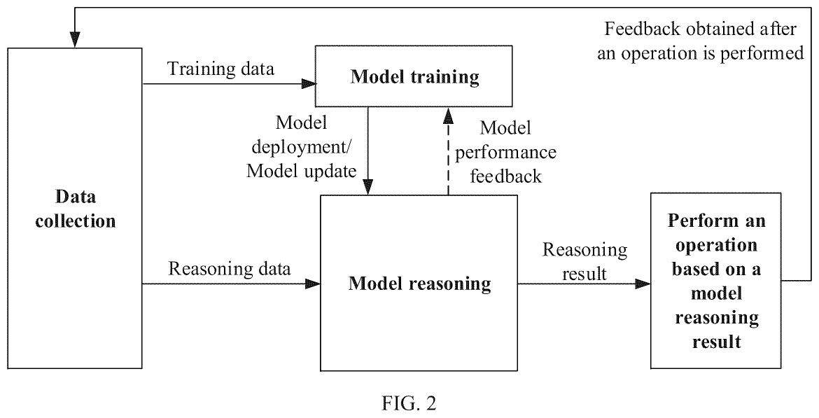

Currently, Artificial Intelligence (AI) is widely used in various fields. To integrate AI into a communication network to significantly improve technical indexes such as a throughput, a delay, and a user capacity is an important optimization direction for future communication networks. An overall AI-based communication network optimization procedure is shown in FIG. 2. A model training function and a model reasoning function are key functions:

The model training function generates an AI model based on training data, and deploys the model to the model reasoning function after completing a model validity test. In a process of generating the AI model, the model training function needs to obtain and analyze a large amount of data, which imposes an extremely high requirement on hardware performance and computing power. The model training function is mainly deployed on a network side device, such as an operator server or a third-party server.

The model reasoning function obtains AI reasoning output such as air interface indicator prediction based on the foregoing AI model by using reasoning data as input. The model reasoning function requires less hardware performance and computing power than the model training function. As terminal capabilities are constantly improved, and even an AI-specific Neural Processing Unit (NPU) is added, AI drive efficiency is constantly improved, so that it is possible to perform model reasoning on a terminal side or even perform partial model training.

The AI model may also be understood as a Machine Learning (ML) model. For ease of description, the following uses an AI model as an example for description.

### 2. Protocol Stacks of a Control Plane and a User Plane

In a mobile communication system, data that needs to be transmitted includes at least user data and control signaling, and the user data and the control signaling have obviously different transmission features. For example, the user data may be in a larger data amount, but the control signaling data may be in a smaller data amount; a delay and reliability required by the control signaling are high; and the control signaling is visible to and terminates in a network, and needs to be processed by the network, but content of the user data is transparent to the network.

In a 5G communication system, if user plane transmission is performed by using a Protocol Data Unit (PDU) session, each PDU session may include one or more Quality of Service (QoS) flows, and each QoS flow may provide a guarantee in terms of quality of service for a user. Before the user transmits data by using the PDU session, the user needs to perform a PDU session establishment process by using the control signaling to establish the PDU session, add or delete the QoS flow by using a PDU session modification process, and delete the PDU session by using a PDU session release process.

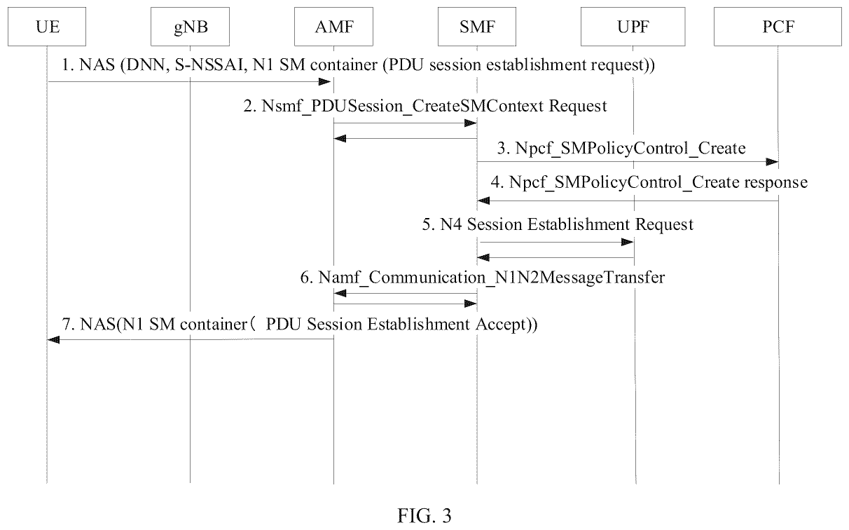

As shown in FIG. 3, the PDU session establishment process is as follows:

(1) When user equipment (UE, that is, a terminal) needs to establish a PDU session, the UE sends a non-access stratum (NAS) message to an Access and Mobility Management Function (AMF), where the message includes a parameter corresponding to the to-be-established PDU session, for example:
a Data Network Name (DNN) used to indicate a Data Network (DN) accessed by the PDU session;
Single Network Slice Selection Assistance information (S-NSSAI) used to indicate a network slice corresponding to the PDU session; and
a request type used to indicate that the current PDU session establishment process is “initial request” or “emergency PDU session”.

The NAS message includes an SM container, and the N1 SM container includes a PDU session establishment request.

The PDU session establishment request includes, for example,
a PDU session type: IPv4, IPv6, or IPv4v6;
information such as a Session and Service Continuity (SSC) mode.

(2) The AMF selects a Session Management Function (SMF) based on information provided by the UE in the NAS message, for example, information such as the DNN, the S-NASAI, or the request type, and sends Nsmf_PDUSession_CreateSMContext Request to the SMF, where the request includes content such as an AMF ID, UE location information, an access type, a Radio Access Technology (RAT) type, and the DNN, the S-NASAI, the request type, and the N1 SM container that are carried by the UE.

The SMF sends Nsmf_PDUSession_CreateSMContext Response to the AMF to notify the AMF whether the SMF accepts the request. If not, subsequent steps may be omitted.

(3) The SMF sends an Npcf_SMPolicyControl_Create request to a PCF to establish an SM Policy Association, and obtains an establishment policy of the PDU session from the PCF.

The request includes information such as the DNN, the S-NSSAI, the RAT type, the PDU session type, the request type, the access type, and the UE location information.

(4) The PCF sends an Npcf_SMPolicyControl_Create response to the SMF, where the message includes policy information for establishing the PDU session, for example, an available session parameter and a QoS parameter.

(5) The SMF selects a User Plane Function (UPF), and initiates an N4 session establishment procedure to the UPF, to establish an N4 session between the SMF and the UPF, so as to control the UPF and a base station to establish a data transmission channel for user transmission.

The UPF returns a response message to the SMF.

(6) The SMF sends an Namf_Communication_N1N2MessageTransfer message to the AMF, where the message includes an N1 SM container, and the N1 SM container includes a PDU session establishment accept message.

The AMF sends a response message to the SMF.

(7) The AMF sends the N1 SM container to the UE by using a NAS message, where the N1 SM container includes the PDU session establishment accept message.

With reference to the accompanying drawings, the following describes in detail an information sending method and apparatus, an information receiving method and apparatus, a terminal, and a network side device in the embodiments of this application based on specific embodiments and application scenarios thereof.

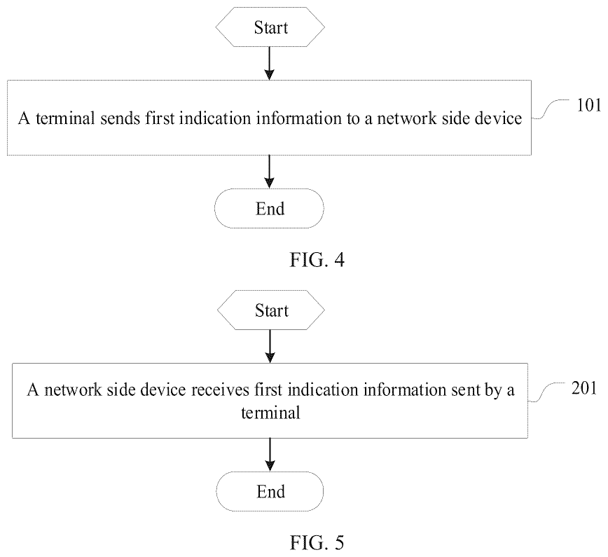

FIG. 4 is a flowchart of an information sending method according to an embodiment of this application. As shown in FIG. 4, the method includes the following steps:

Step 101: A terminal sends first indication information to a network side device, where the first indication information is used to request an address of a server; where
the first indication information is carried in a first message, and the first message is used for at least one of the following:
establishing a Protocol Data Unit (PDU) session;
modifying the PDU session; or
registration.

The first message may be a message in a process of establishing the PDU session, for example, the first message may be a PDU session establishment request message; and/or the first message may be a message in a PDU session modification process, for example, the first message may be a PDU session modification request message; and/or the first message may be a message in a registration process, for example, the first message may be a register request message.

In an implementation, registration may be 5G system registration (register), 4G system registration, 6G system registration, or the like. The registration may refer to network registration.

In an implementation, the address of the server may be described as a server address.

In an implementation, the server address may be a server address used to provide a computing power service, the server address may be a computing power server address, and a computing power service may be obtained by using the address of the server.

In an implementation, the server address may be a server address used to provide a sensing service, the server address may be a sensing server address, and a sensing service may be obtained by using the server address.

In an implementation, the server address may be a server address used to provide an AI model updating service, the server address may be a server address corresponding to an AI model, and an AI model updating service may be obtained by using the address of the server. For example, the address of the server may be an updated address of the AI model, and the terminal may access the address of the server to update the AI model.

In an implementation, the server address may be a server address used to provide an AI model downloading service, the server address may be a server address corresponding to an AI model, and an AI model downloading service may be obtained by using the address of the server. For example, the address of the server may be a server downloading address of the AI model, and the terminal may access the address of the server to download the AI model.

It should be noted that 3GPP is studying AI-based communication performance enhancement, to further improve communication performance of the terminal, for example, communication performance of an air interface-related function. In an AI-based communication performance enhancement process, the terminal needs to perform reasoning based on the AI model. For an AI model corresponding to a specific function, when a scenario in which the terminal is located is significantly different from a scenario corresponding to input data of a training model due to moving of the terminal, reasoning result performance of the AI model may decrease, and even it is difficult to meet a performance requirement of a reasoning result of the function. Therefore, to achieve an optimal communication effect, the terminal needs to download a latest AI model from a network side. Currently, there is no solution to how the terminal downloads the AI model from a network. In this embodiment, the terminal sends the first indication information to the network side device, where the first indication information is carried in the first message, and the first indication information is used to request the address of the server. The address of the server may be a downloading address of the AI model, and UE can be supported to obtain the downloading address of the AI model, so that the AI model can be dynamically adjusted to improve a communication effect.

In this embodiment of this application, the terminal sends the first indication information to the network side device, where the first indication information is used to request the address of the server, the first indication information is carried in the first message, and the first message is used for at least one of the following: establishing a protocol data unit PDU session; modifying the PDU session; or registration. In this way, the address of the server is requested by using the first indication information carried in the first message, so that flexibility of obtaining, by the terminal, the address of the server that provides a service for the terminal can be improved.

In some embodiments, the server includes at least one of the following:
a server that provides an artificial intelligence AI model downloading service;
a server that provides an AI model updating service;
a server that provides a computing power service; or
a server that provides a sensing service.

In some embodiments, the UE may upload an AI model trained by the UE to the server. Therefore, the server may be a server that provides an AI model uploading service.

In this implementation, the first indication information carried in the first message is used to request a server address for providing the AI model downloading service, so that the terminal better obtains the AI model downloading service; the first indication information carried in the first message is used to request the server that provides the AI model updating service, so that the terminal better obtains the AI model updating service; the first indication information carried in the first message is used to request the server that provides the computing power service, so that the terminal better obtains the computing power service; and the first indication information carried in the first message is used to request the server that provides the sensing service, so that the terminal better obtains the sensing service.

In some embodiments, in a case that the first message is used for establishing the PDU session, the first indication information is included in at least one of the following:
a PDU session parameter;
a 5G Session Management (SM) core network capability Information Elements (IE);
an SM PDU Data Network (DN) request container IE;
an N1 SM container IE; or
Protocol Configuration Option (PCO) information.

The first message may be a PDU session establishment request message. The PDU session parameter may be a special PDU session parameter, such as a special DNN or S-NSSAI.

In an implementation, as an example, the address of the server is a server address corresponding to corresponding to the AI model. The server address corresponding to the AI model may be obtained in a process of establishing the PDU session. When requesting to establish the PDU session, the UE (that is, the terminal) carries the first indication information. An SMF sends, in a PDU session establishment accept message, the server address corresponding to the AI model to the UE based on the first indication information, and the UE requests to download the AI model from the server address of the AI model.

The UE may carry the first indication information in at least one of the following five manners:

Manner 1: The first indication information is carried by using a special PDU session parameter, such as a special DNN, S-NSSAI, or a capability of the AI model supported by the UE.

Manner 2: The first indication information is carried in 5GSM Core Network Capability, where the first indication information is an indication that AI model updating/downloading is supported, or a capability of the AI model supported by the UE.

Manner 3: The first indication information is included in an SM PDU DN request container, where the first indication information is information used to authorize the UE by a server corresponding to the AI model, or a capability of the AI model supported by the UE.

Manner 4: The first indication information is included in an N1 SM container, where the first indication information is an indication of requesting the server address corresponding to the AI model, or a capability of the AI model supported by the UE.

Manner 5: The first indication information is included in a Protocol Configuration Options (PCO), where the first indication information is an indication of requesting the server address corresponding to the AI model, or a capability of the AI model supported by the UE.

In some embodiments, the capability of the AI model supported by the UE includes at least one of the following:
an identifier (ID) of the AI model supported by the UE;
a function or usage of the AI model supported by the UE;
a type of the AI model supported by the UE;
a size of the AI model supported by the UE;
a computing amount of the AI model supported by the UE;
vendor or provider identity qualification information of the AI model supported by the UE;
a representation manner of the AI model supported by the UE, for example, supported model language; or
a performance requirement for the AI model supported by the UE.

It should be noted that, for the manner 1, the manner 2, the manner 3, and the manner 4, an SMF may send the server address corresponding to the AI model to the UE by using the N1 SM container or the PDU session access accept message; and for the manner 5, the SMF may send the server address corresponding to the AI model by using the PCO.

In some embodiments, the first indication information may be specific indication information, for example, the manner 2, the manner 4, or the manner 5; or the first indication information may be implicit indication information, for example, the manner 1 and the manner 3, and in this case, the network side device SMF may determine, based on the information, that the server address needs to be sent to the UE.

In addition, the SMF may store the server address corresponding to the AI model, or obtain, from a PCF, the server address corresponding to the AI model.

In this implementation, the first indication information used to request the address of the server is carried by using at least one of the PDU session parameter, the 5G SM core network capability IE, the SM PDU DN request container IE, the N1 SM container IE, or the PCO information in the PDU session establishment process, so that flexibility of obtaining, by the terminal, the address of the server that provides a service for the terminal can be improved, and no additional signaling overheads are required to obtain the address of the server.

In some embodiments, in a case that the first message is used for modifying the PDU session, the first indication information is included in at least one of the following:
quality of service QoS requirement information;
a 5GSM core network capability IE;
an SM container IE; or
PCO information.

The first message may be a PDU session modification request message. The QoS requirement information may be a special QoS requirement, for example, a special 5G quality of service identifier (5G QoS Identifier, 5QI) value.

In an implementation, as an example, the address of the server is a server address corresponding to the AI model. The server address corresponding to the AI model may be obtained in a process of modifying the PDU session. After the UE establishes the PDU session, when the UE needs to download the AI model, the UE adds the first indication information to the PDU session modification request, the SMF sends, based on the first indication information, the server address corresponding to the AI model to the UE in a PDU session modification accept message, and the UE requests to download the AI model from the server address of the AI model.

The UE may carry the first indication information in at least one of the following four manners:

Manner 6: The first indication information is carried in a QoS flow used by the UE to request to establish a special QoS requirement, and the SMF sends, to the UE based on the special QoS requirement, a server address for downloading the AI model.

Manner 7: The first indication information is carried in 5GSM Core Network Capability, where the first indication information is an indication that AI model updating/downloading is supported, or a capability of the AI model supported by the UE.

Manner 8: The first indication information is included in an SM container, where the first indication information is an indication of requesting the server address corresponding to the AI model, or a capability of the AI model supported by the UE.

Manner 9: The first indication information is included in the PCO, where the first indication information is an indication of requesting the server address corresponding to the AI model, or a capability of the AI model supported by the UE.

In some embodiments, the capability of the AI model supported by the UE includes at least one of the following:
an identifier (ID) of the AI model supported by the UE;
a function or usage of the AI model supported by the UE;
a type of the AI model supported by the UE;
a size of the AI model supported by the UE;
a computing amount of the AI model supported by the UE;
vendor or provider identity qualification information of the AI model supported by the UE;
a representation manner of the AI model supported by the UE, for example, supported model language; or
a performance requirement for the AI model supported by the UE.

In this implementation, the first indication information used to request the address of the server is carried by using at least one of the QoS requirement information, the 5G SM core network capability IE, the SM container IE, or the PCO information in the PDU session modification process, so that flexibility of obtaining, by the terminal, the address of the server that provides a service for the terminal can be improved, and no additional signaling overheads are required to obtain the address of the server.

In some embodiments, in a case that the first message is used for registration, the first indication information is included in at least one of the following:
a user equipment (UE) mobility management (MM) core network capability IE;
a 5GS update option (update type) IE; or
a UE policy container IE.

The first message may be a register request message.

In an implementation, as an example, the address of the server is a server address corresponding to the AI model. The UE may obtain the server address corresponding to the AI model in a 5G system registration (register) process. The UE carries the first indication information during registration, and the AMF or the PCF sends the server address corresponding to the AI model to the UE based on the first indication information.

The UE may carry the first indication information in at least one of the following four manners:

Manner 10: The first indication information is carried in UE MM Core Network Capability, where the first indication information is an indication that AI model updating/downloading is supported, or a capability of the AI model supported by the UE.

Manner 11: The first indication information is carried in 5GS update type.

Manner 12: The first indication information is carried, where the first indication information is an indication of requesting the server address corresponding to the AI model, or a capability of the AI model supported by the UE.

Manner 13: The first indication information is carried in the UE policy container, where the first indication information is an indication that AI model updating/downloading is supported, or a capability of the AI model supported by the UE.

In some embodiments, the capability of the AI model supported by the UE includes at least one of the following:
an identifier (ID) of the AI model supported by the UE;
a function or usage of the AI model supported by the UE;
a type of the AI model supported by the UE;
a size of the AI model supported by the UE;
a computing amount of the AI model supported by the UE;
vendor or provider identity qualification information of the AI model supported by the UE;
a representation manner of the AI model supported by the UE, for example, supported model language; or
a performance requirement for the AI model supported by the UE.

For the manner 10, the manner 11, and the manner 12, the AMF sends the server address corresponding to the AI model to the UE by using a register accept message.

For the manner 13, the PCF sends the server address corresponding to the AI model by using the UE policy container.

In this implementation, the first indication information used to request the address of the server is carried by using at least one of the UE MM core network capability IE, the 5GS update option, or the UE policy container IE in the registration process, so that flexibility of obtaining, by the terminal, the address of the server that provides a service for the terminal can be improved, and no additional signaling overheads are required to obtain the address of the server.

In some embodiments, the method further includes:
receiving, by the terminal, second indication information sent by the network side device, where the second indication information is used to indicate the address of the server; and
establishing, by the terminal, a communication connection to the server based on the second indication information.

The second indication information may be carried in a second message, and the second message may be used for at least one of the following: establishing a protocol data unit PDU session; modifying the PDU session; or registration. In a case that the first message is used for establishing the PDU session, the second message is used for establishing the PDU session. In a case that the first message is used for modifying the PDU session, the second message is used for modifying the PDU session. In a case that the first message is used for registration, the second message is used for registration.

In an implementation, the communication connection herein may be any connection that can be used for communication transmission. For example, the communication connection includes at least one of the following:
a Real-time Transport Protocol (RTP) connection;
an Application Data Channel (Application DC);
an IP connection;
a Transmission Control Protocol (TCP) connection;
a User Datagram Protocol (UDP) connection; or
a non-access stratum (NAS) connection.

It should be noted that, in a case that the address of the server is the address of the server used to provide the computing power service, the terminal establishes a communication connection to the server based on the address of the server, so that the terminal can obtain the computing power service from the server; in a case that the address of the server is the address of the server used to provide the sensing service, the terminal establishes a communication connection to the server based on the address of the server, so that the terminal can obtain the sensing service from the server; in a case that the address of the server is the address of the server used to provide the AI model updating service, the terminal establishes a communication connection to the server based on the address of the server, so that the terminal can obtain the AI model updating service from the server; and in a case that the address of the server is the address of the server used to provide the AI model downloading service, the terminal establishes a communication connection to the server based on the address of the server, so that the terminal can obtain the AI model downloading service from the server.

It should be noted that in a related technology, only a solution for data transmission of a common user is provided for the UE, and there is no solution for how to download the AI model. Downloading the AI model includes obtaining address information of the AI model and downloading the AI model. In this embodiment, the terminal receives the second indication information sent by the network side device, where the second indication information is used to indicate the address of the server, and the address of the server may be an address for downloading the AI model, so that the UE can download the AI model, and thus, the AI model can be dynamically adjusted, thereby improving a communication effect.

In this implementation, the terminal receives the second indication information sent by the network side device, where the second indication information is used to indicate the address of the server; and the terminal establishes the communication connection to the server based on the second indication information. Therefore, flexibility of obtaining, by the terminal, the server address that provides a service for the terminal can be improved.

In some embodiments, in a case that the first message is used for establishing the PDU session, the second indication information is included in at least one of the following:
a PDU session establishment accept message;
an N1 SM container IE; or
PCO information.

The address of the server may be obtained in a process of establishing the PDU session. In the process of establishing the PDU session, the network side device may send the address of the server to the terminal by using at least one of the PDU session establishment accept message, the N1 SM container IE, or the PCO information. For example, the network side device may include an SMF. In the process of establishing the PDU session, the SMF sends the address of the server to the terminal by using at least one of the PDU session establishment accept message, the N1 SM container IE, or the PCO information.

In this implementation, the address of the server is carried by using at least one of the PDU session establishment accept message, the N1 SM container IE, or the PCO information in the process of establishing the PDU session, so that flexibility of obtaining, by the terminal, the address of the server that provides a service for the terminal can be improved, and no additional signaling overheads are required to obtain the address of the server.

In some embodiments, in a case that the first message is used for modifying the PDU session, the second indication information is included in at least one of the following:
a PDU session modification accept message;
an N1 SM container IE; or
PCO information.

The address of the server may be obtained in a process of modifying the PDU session. In the process of modifying the PDU session, the network side device may send the address of the server to the terminal by using at least one of the PDU session modification accept message, the N1 SM container IE, or the PCO information. For example, the network side device may include an SMF. In the process of modifying the PDU session, the SMF sends the address of the server to the terminal by using at least one of the PDU session modification accept message, the N1 SM container IE, or the PCO information.

In this implementation, the address of the server is carried by using at least one of the PDU session modification accept message, the N1 SM container IE, or the PCO information in the process of modifying the PDU session, so that flexibility of obtaining, by the terminal, the address of the server that provides a service for the terminal can be improved, and no additional signaling overheads are required to obtain the address of the server.

In some embodiments, the network side device includes a session management function SMF.

In an implementation, the address of the server is an address stored in the SMF, or the address of the server is obtained by the SMF from a policy control function PCF.

In some embodiments, the address of the server is determined by the network side device based on a PDU session parameter of the terminal, and the PDU session parameter includes at least one of the following: a terminal location, a radio access technology RAT type, a data network name DNN, single network slice selection assistance information S-NSSAI, or an access type.

The address of the server that is indicated by the second indication information may be determined by the network side device based on the PDU session parameter of the terminal. To be specific, the address of the server that is indicated by the second indication information may be determined by using at least one of the terminal location, the radio access technology RAT type, the data network name DNN, the single network slice selection assistance information S-NSSAI, or the access type. The server may be a server that matches at least one of the terminal location, the radio access technology RAT type, the data network name DNN, the single network slice selection assistance information S-NSSAI, or the access type in the PDU session parameter.

It should be noted that the terminal location, the radio access technology RAT type, the data network name DNN, the single network slice selection assistance information S-NSSAI, and the access type in the PDU session parameter can each reflect a scenario in which the terminal is located, and the address of the server is determined by using the PDU session parameter of the terminal, so that the server corresponding to the obtained server address can better provide a service for the terminal.

In some embodiments, in a case that the first message is used for registration, the second indication information is included in at least one of the following:
a register accept message; or
a UE policy container IE.

The address of the server may be obtained in a registration process. In the registration process, the network side device may send the address of the server to the terminal by using at least one of the register accept message or the UE policy container IE. For example, the network side device may include an AMF, and in the registration process, the AMF sends the address of the server to the terminal by using the register accept message. In some embodiments, the network side device may include a PCF, and in the registration process, the PCF sends the address of the server to the terminal by using the UE policy container IE.

In this implementation, the address of the server is carried by using at least one of the register accept message or the UE policy container IE in the registration process, so that flexibility of obtaining, by the terminal, the address of the server that provides a service for the terminal can be improved, and no additional signaling overheads are required to obtain the address of the server.

In some embodiments, the receiving, by the terminal, second indication information sent by the network side device includes:
receiving, by the terminal, the register accept message sent by a first AMF, where the register accept message carries the second indication information; and
receiving, by the terminal, the UE policy container IE sent by a PCF, where the UE policy container IE carries the second indication information.

In an implementation, the address of the server is obtained by the first AMF from a unified data management entity UDM, or is obtained by the first AMF from a second AMF, where the second AMF is an AMF that has provided a service for the terminal.

In some embodiments, the address of the server includes at least one of the following:
an internet protocol (IP) address;
a fully qualified domain name (FQDN); or
a website.

FIG. 5 is a flowchart of an information receiving method according to an embodiment of this application. As shown in FIG. 5, the information receiving method includes the following steps:

Step 201: A network side device receives first indication information sent by a terminal, where the first indication information is used to request an address of a server; where
the first indication information is carried in a first message, and the first message is used for at least one of the following:
establishing a protocol data unit PDU session;
modifying the PDU session; or
registration.

In some embodiments, the server includes at least one of the following:
a server that provides an artificial intelligence AI model downloading service;
a server that provides an AI model updating service;
a server that provides a computing power service; or
a server that provides a sensing service.

In some embodiments, in a case that the first message is used for establishing the PDU session, the first indication information is included in at least one of the following:
a PDU session parameter;
a 5G session management SM core network capability information element IE;
an SM PDU data network DN request container IE;
an N1 SM container IE; or
protocol configuration option PCO information.

In some embodiments, in a case that the first message is used for modifying the PDU session, the first indication information is included in at least one of the following:
quality of service QoS requirement information;
a 5GSM core network capability IE;
an SM container IE; or
PCO information.

In some embodiments, in a case that the first message is used for registration, the first indication information is included in at least one of the following:
a user equipment UE mobility management MM core network capability IE;
a 5GS update option IE; or
a UE policy container IE.

In some embodiments, the method further includes:
sending, by the network side device, second indication information to the terminal, where the second indication information is used to indicate the address of the server.

In some embodiments, in a case that the first message is used for establishing the PDU session, the second indication information is included in at least one of the following:
a PDU session establishment accept message;
an N1 SM container IE; or
PCO information.

In some embodiments, in a case that the first message is used for modifying the PDU session, the second indication information is included in at least one of the following:
a PDU session modification accept message;
an N1 SM container IE; or
PCO information.

In some embodiments, the network side device includes a session management function SMF, and the address of the server is an address stored in the SMF, or the address of the server is obtained by the SMF from a policy control function PCF.

In some embodiments, the address of the server is determined by the network side device based on a PDU session parameter of the terminal, and the PDU session parameter includes at least one of the following: a terminal location, a radio access technology RAT type, a data network name DNN, single network slice selection assistance information S-NSSAI, or an access type.

In some embodiments, in a case that the first message is used for registration, the second indication information is included in at least one of the following:
a register accept message; or
a UE policy container IE.

In some embodiments, the sending, by the network side device, second indication information to the terminal includes:
the network side device includes a first AMF, the first AMF sends the register accept message to the terminal, the register accept message carries the second indication information, the address of the server is obtained by the first AMF from a unified data management entity UDM, or the first AMF is obtained by the first AMF from a second AMF, and the second AMF is an AMF that has provided a service for the terminal; and
the network side device includes a PCF, the PCF sends the UE policy container IE to the terminal, the UE policy container IE carries the second indication information, and the UE policy container IE is obtained by the PCF from the first AMF.

In some embodiments, the address of the server includes at least one of the following:
an internet protocol IP address;
a fully qualified domain name FQDN; or
a website.

It should be noted that this embodiment is used as an implementation of the network side device corresponding to the embodiment shown in FIG. 4. For a specific implementation of this embodiment, reference may be made to the related descriptions of the embodiment shown in FIG. 4. To avoid repetition, details are not described in this embodiment again. In this way, the address of the server is requested by using the first indication information carried in the first message, so that flexibility of obtaining, by the terminal, the address of the server that provides a service for the terminal can be improved.

The information sending method and the information receiving method provided in the embodiments of this application are described below by using three specific embodiments.

### Embodiment 1

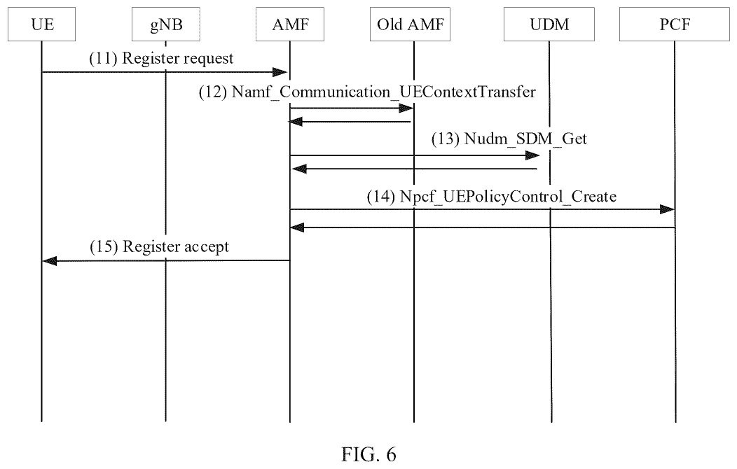

In this embodiment, in a process in which UE registers (register) with a 5G system, a server address corresponding to an AI model is obtained. As shown in FIG. 6, a specific process of obtaining the server address corresponding to the AI model is as follows:

(11) The UE initiates a register request, where the register request includes indication information, and the indication information is used to indicate “request the server address corresponding to the AI model”. The UE performs indication in the following several manners:

Option 1: An indication indicating that AI model updating/downloading is supported is carried in UE MM Core Network Capability, that is, an indication indicating whether AI model updating/downloading is supported is added based on existing UE MM Core Network Capability.

Option 2: An indication indicating that the UE requests “the server address corresponding to the AI model” is carried in 5GS update type.

Option 3: A newly added indication is used to request an indication of “the server address corresponding to the AI model”.

Option 4: UE Policy Container includes an indication indicating that AI model updating/downloading is supported.

(12) In some embodiments, an AMF requests context of the UE from an AMF that has previously provided a service for the UE, that is, an old AMF.

In some embodiments, the old AMF provides the server address corresponding to the AI model for the AMF.

(13) In some embodiments, the AMF obtains subscription information of the UE from a UDM.

In some embodiments, the UDM provides the server address corresponding to the AI model for the UDM.

(14) The AMF sends UE Policy Container to the PCF by using an Npcf_UEPolicyControl Create message.

In some embodiments, the UE Policy Container includes an indication indicating that AI model updating/downloading is supported.

The PCF provides the server address corresponding to the AI model for the UE by using the UE Policy Container.

(15) The AMF includes the server address corresponding to the AI model in a register accept message.

For the options 1 to 3, the AMF sends the server address corresponding to the AI model to the UE by using the register accept message.

For the option 4, the AMF sends the server address corresponding to the AI model by using the UE Policy Container.

It should be noted that in the option 4, the AMF does not parse content of the UE Policy Container, and the AMF transparently transmits the UE Policy Container to the UE.

### Embodiment 2

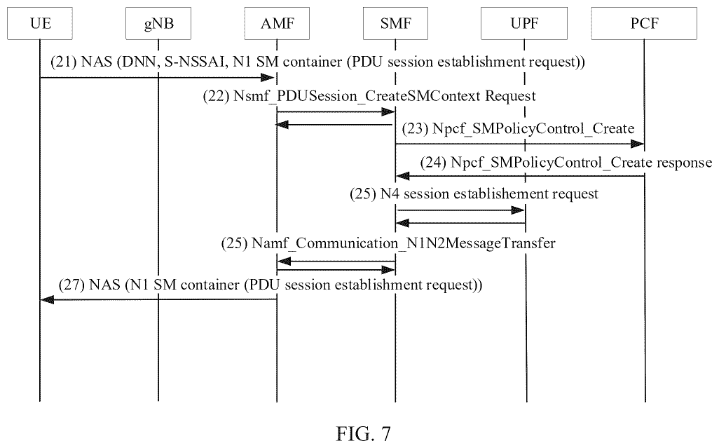

In this embodiment, an address of a server corresponding to an AI model is obtained in a process of establishing a PDU session. As shown in FIG. 7, a specific process of obtaining the server address corresponding to the AI model is as follows:

(21) When UE needs to establish a PDU session, the UE sends a NAS message to an AMF, where the message includes a parameter corresponding to the to-be-established PDU session, and the NAS message carries indication information. The indication information is used to indicate “request a server address corresponding to an AI model”. The UE performs indication in the following several manners:

Option 1: The indication information is carried by using a special PDU session parameter, such as a special DNN or S-NSSAI.

The indication information is included in a NAS message.

Option 2: An indication indicating that AI model updating/downloading is supported is carried in 5GSM Core Network Capability, that is, an indication indicating whether AI model updating/downloading is supported is added based on existing 5GSM Core Network Capability.

The indication information is included in a PDU session establishment request.

Option 3: An SM PDU DN Request Container includes information used by an AI model server to authorize whether AI model updating/downloading is allowed for the UE.

The indication information is included in a PDU session establishment request.

Option 4: An N1 SM container includes an indication for requesting “the server address corresponding to the AI model”.

The indication information is included in the N1 SM container.

Option 5: A PCO includes an indication for requesting “the server address corresponding to the AI model”.

The indication information is included in a PDU session establishment request.

(22) is the same as step (12) in Embodiment 1.

(23) An SMF sends an Npcf_SMPolicyControl_Create request to a PCF to establish an SM policy association, and obtains an establishment policy of the PDU session from the PCF.

The request includes information such as the DNN, the S-NSSAI, the RAT type, the PDU session type, the request type, the access type, and the UE location information.

In some embodiments, the SMF sends an indication for requesting “the server address corresponding to the AI model” to the PCF.

(24) The PCF sends an Npcf_SMPolicyControl_Create response to the SMF, where the message includes policy information for establishing the PDU session, for example, an available session parameter and a QoS parameter.

In some embodiments, the PCF sends the server address corresponding to the AI model to the SMF.

(25) is the same as step (15) in Embodiment 1.

(26) The SMF sends an Namf_Communication_N1N2Message Transfer message to the AMF, where the message includes an N1 SM container, and the N1 SM container includes a PDU session establishment accept message.

In some embodiments, the AMF sends a response message to the SMF.

In some embodiments, the SMF sends the server address corresponding to the AI model to the UE by using the N1 SM container or the PDU session access accept message, or the SMF sends the server address corresponding to the AI model by using the PCO.

In addition, the server address corresponding to the AI model is an address locally stored in the SMF or obtained from the PCF.

The SMF or the PCF may determine, based on a PDU session parameter of the UE, the server address corresponding to the AI model. For example, the server address corresponding to the AI model is determined based on information such as location information of the UE, a RAT type, a DNN, S-NSSAI, and an access type.

(27) The AMF sends the N1 SM container to the UE by using a NAS message, where the N1 SM container includes the PDU session establishment accept message.

The NAS message includes the server address corresponding to the AI model.

In addition, the UE requests to download or update the AI model from the server address corresponding to the AI model.

It should be noted that, in addition to obtaining the server address for downloading or updating the AI model, this embodiment may be further used to obtain an address of another type of server, for example, address information of a computing power server.

### Embodiment 3

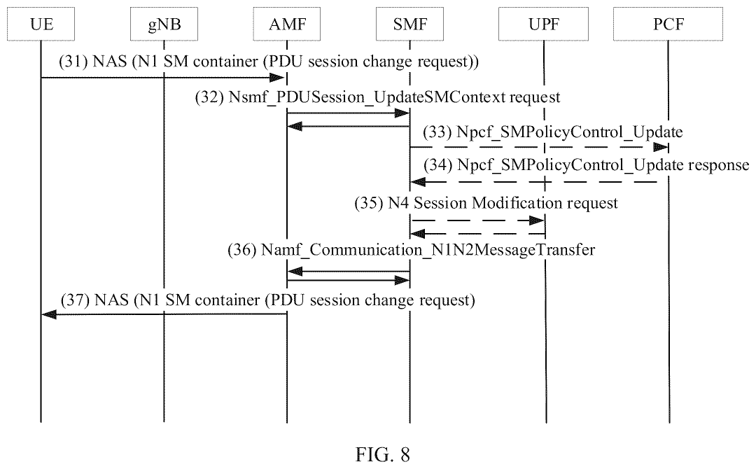

In this embodiment, a server address corresponding to an AI model is obtained in a process of modifying a PDU session. As shown in FIG. 8, a specific process of obtaining the server address corresponding to the AI model is as follows:

(31) After UE establishes a PDU session, when the UE needs to download the AI model, the UE sends a NAS message to the AMF, where the NAS message carries indication information, and the indication information is used to indicate “request a server address corresponding to the AI model”. The UE performs indication in the following several manners:

Option 1. The indication information is carried by using a special QoS requirement, for example, a 5G quality of service identifier (5G QoS Identifier, 5QI) value.

The indication information is included in a PDU session modification request.

Option 2: An indication indicating that AI model updating/downloading is supported is carried in 5GSM Core Network Capability, that is, an indication indicating whether AI model updating/downloading is supported is added based on existing 5GSM Core Network Capability.

The indication information is included in a PDU session modification request.

Option 3: An N1 SM container includes an indication for requesting “the server address corresponding to the AI model”.

The indication information is included in the N1 SM container:

Option 4: A PCO includes an indication for requesting “the server address corresponding to the AI model”.

The indication information is included in a PDU session establishment request.

(32) The AMF sends an Nsmf_PDUSession_UpdateSMContext request to an SMF that currently provides a service for the UE.

In addition, the SMF sends an Nsmf_PDUSession_UpdateSMContext response to the AMF to notify the AMF whether the SMF accepts the request. If not, subsequent steps may be omitted.

(33) In some embodiments, the SMF sends an Npcf_SMPolicyControl_Update request to the PCF to modify an SM policy association.

The request includes parameter information of a QoS flow that the UE requests to establish.

In some embodiments, the SMF sends an indication for requesting “the server address corresponding to the AI model” to the PCF.

(34) In some embodiments, the PCF sends an Npcf_SMPolicyControl_Update response to the SMF, where the message includes policy information for establishing the QoS flow, for example, an available QoS parameter.

In some embodiments, the PCF sends the server address corresponding to the AI model to the SMF.

(35) is the same as step (15) in Embodiment 1.

(36) The SMF sends an Namf_Communication_N1N2MessageTransfer message to the AMF, where the message includes an N1 SM container, and the N1 SM container includes a PDU session modification accept message.

The AMF sends a response message to the SMF.

In some embodiments, the SMF sends the server address corresponding to the AI model to the UE by using the N1 SM container or the PDU session access accept message, or the SMF sends the server address corresponding to AI model by using the PCO.

The server address corresponding to the AI model is an address locally stored in the SMF or obtained from the PCF.

The SMF or the PCF may determine, based on a PDU session parameter of the UE, the server address corresponding to the AI model. For example, the server address corresponding to the AI model is determined based on information such as location information of the UE, a RAT type, a DNN, S-NSSAI, and an access type.

(37) The AMF sends an N1 SM container to the UE by using a NAS message, where the N1 SM container includes the PDU session modification accept message.

In some embodiments, the NAS message includes the server address corresponding to the AI model.

In some embodiments, the UE requests to download or update the AI model from the server address corresponding to the AI model.

It should be noted that, in addition to obtaining the server address for downloading or updating the AI model, this embodiment may be further used to obtain an address of another type of server, for example, address information of a computing power server.

The information sending method provided in the embodiments of this application may be performed by an information sending apparatus. In this embodiment of this application, that an information sending apparatus performs the information sending method is used as an example to describe the information sending apparatus provided in an embodiment of this application.

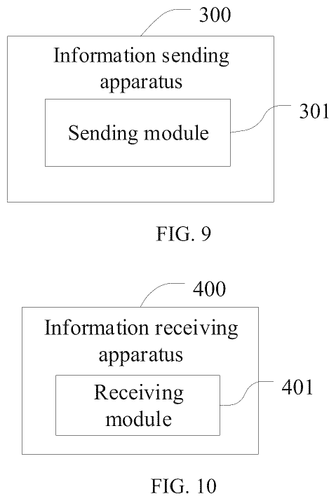

FIG. 9 is a structural diagram of an information sending apparatus according to an embodiment of this application. A terminal includes the information sending apparatus. As shown in FIG. 9, an information apparatus 300 includes:
a sending module 301, configured to send first indication information to a network side device, where the first indication information is used to request an address of a server; where
the first indication information is carried in a first message, and the first message is used for at least one of the following:
establishing a protocol data unit PDU session;
modifying the PDU session; or
registration.

In some embodiments, the server includes at least one of the following:
a server that provides an artificial intelligence AI model downloading service;
a server that provides an AI model updating service;
a server that provides a computing power service; or
a server that provides a sensing service.

In some embodiments, in a case that the first message is used for establishing the PDU session, the first indication information is included in at least one of the following:
a PDU session parameter;
a 5G session management SM core network capability information element IE;
an SM PDU data network DN request container IE;
an N1 SM container IE; or
protocol configuration option PCO information.

In some embodiments, in a case that the first message is used for modifying the PDU session, the first indication information is included in at least one of the following:
quality of service QoS requirement information;
a 5GSM core network capability IE;
an SM container IE; or
PCO information.

In some embodiments, in a case that the first message is used for registration, the first indication information is included in at least one of the following:
a user equipment UE mobility management MM core network capability IE;
a 5GS update option IE; or
a UE policy container IE.

In some embodiments, the apparatus further includes:
a receiving module, configured to receive second indication information sent by the network side device, where the second indication information is used to indicate the address of the server; and
a connection module, configured to establish a communication connection to the server based on the second indication information.

In some embodiments, in a case that the first message is used for establishing the PDU session, the second indication information is included in at least one of the following:
a PDU session establishment accept message;
an N1 SM container IE; or
PCO information.

In some embodiments, in a case that the first message is used for modifying the PDU session, the second indication information is included in at least one of the following:
a PDU session modification accept message;
an N1 SM container IE; or
PCO information.

In some embodiments, the network side device includes a session management function SMF.

In some embodiments, in a case that the first message is used for registration, the second indication information is included in at least one of the following:
a register accept message; or
a UE policy container IE.

In some embodiments, the receiving module is configured to perform at least one of the following:
receive the register accept message sent by a first AMF, where the register accept message carries the second indication information; or
receive the UE policy container IE sent by a PCF, where the UE policy container IE carries the second indication information.

In some embodiments, the address of the server includes at least one of the following:
an internet protocol IP address;
a fully qualified domain name FQDN; or
a website.

In the information sending apparatus in this embodiment of this application, the sending module sends the first indication information to the network side device, where the first indication information is used to request the address of the server, the first indication information is carried in the first message, and the first message is used for at least one of the following: establishing a protocol data unit PDU session; modifying the PDU session; or registration. In this way, the address of the server is requested by using the first indication information carried in the first message, so that flexibility of obtaining, by the terminal, the address of the server that provides a service for the terminal can be improved.

The information sending apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not specifically limited in this embodiment of this application.

The information sending apparatus provided in this embodiment of this application can implement each process implemented in the method embodiment of FIG. 4, and a same technical effect is achieved. To avoid repetition, details are not described herein again.

The information receiving method provided in the embodiments of this application may be performed by an information receiving apparatus. In this embodiment of this application, that an information receiving apparatus performs the information receiving method is used as an example to describe the information receiving apparatus provided in an embodiment of this application.

FIG. 10 is a structural diagram of an information receiving apparatus according to an embodiment of this application. A network side device includes the information receiving apparatus. As shown in FIG. 10, an information receiving apparatus 400 includes:
a receiving module 401, configured to receive first indication information sent by a terminal, where the first indication information is used to request an address of a server; where
the first indication information is carried in a first message, and the first message is used for at least one of the following:
establishing a protocol data unit PDU session;
modifying the PDU session; and
registration.

In some embodiments, the server includes at least one of the following:
a server that provides an artificial intelligence AI model downloading service;
a server that provides an AI model updating service;
a server that provides a computing power service; and
a server that provides a sensing service.

In some embodiments, in a case that the first message is used for establishing the PDU session, the first indication information is included in at least one of the following:
a PDU session parameter;
a 5G session management SM core network capability information element IE;
an SM PDU data network DN request container IE;
an N1 SM container IE; and
protocol configuration option PCO information.

In some embodiments, in a case that the first message is used for modifying the PDU session, the first indication information is included in at least one of the following:
quality of service QoS requirement information;
a 5GSM core network capability IE;
an SM container IE; and
PCO information.

In some embodiments, in a case that the first message is used for registration, the first indication information is included in at least one of the following:
a user equipment UE mobility management MM core network capability IE;
a 5GS update option IE; and
a UE policy container IE.

In some embodiments, the apparatus further includes:
a sending module, configured to send second indication information to the terminal, where the second indication information is used to indicate the address of the server.

In some embodiments, in a case that the first message is used for establishing the PDU session, the second indication information is included in at least one of the following:
a PDU session establishment accept message;
an N1 SM container IE; and
PCO information.

In some embodiments, in a case that the first message is used for modifying the PDU session, the second indication information is included in at least one of the following:
a PDU session modification accept message;
an N1 SM container IE; and
PCO information.

In some embodiments, the network side device includes a session management function SMF, and the address of the server is an address stored in the SMF, or the address of the server is obtained by the SMF from a policy control function PCF.

In some embodiments, the address of the server is determined by the network side device based on a PDU session parameter of the terminal, and the PDU session parameter includes at least one of the following: a terminal location, a radio access technology RAT type, a data network name DNN, single network slice selection assistance information S-NSSAI, and an access type.

In some embodiments, in a case that the first message is used for registration, the second indication information is included in at least one of the following:
a register accept message; and
a UE policy container IE.

In some embodiments, the sending module is configured to perform at least one of the following:
in a case that the network side device includes a first AMF, sending the register accept message to the terminal, where the register accept message carries the second indication information, the address of the server is obtained by the first AMF from a unified data management entity UDM, or the first AMF is obtained by the first AMF from a second AMF, where the second AMF is an AMF that has provided a service for the terminal; and
in a case that the network side device includes a PCF, sending the UE policy container IE to the terminal, where the UE policy container IE carries the second indication information, and the UE policy container IE is obtained by the PCF from the first AMF.

In some embodiments, the address of the server includes at least one of the following:
an internet protocol IP address;
a fully qualified domain name FQDN; and
a website.

In the information receiving apparatus in this embodiment of this application, the receiving module receives the first indication information sent by the terminal, where the first indication information is used to request the address of the server, the first indication information is carried in the first message, and the first message is used for at least one of the following: establishing a protocol data unit PDU session; modifying the PDU session; and registration. In this way, the address of the server is requested by using the first indication information carried in the first message, so that flexibility of obtaining, by the terminal, the address of the server that provides a service for the terminal can be improved.

The information receiving apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not specifically limited in this embodiment of this application.

The information receiving apparatus provided in this embodiment of this application can implement each process implemented in the method embodiment of FIG. 5, and a same technical effect is achieved. To avoid repetition, details are not described herein again.

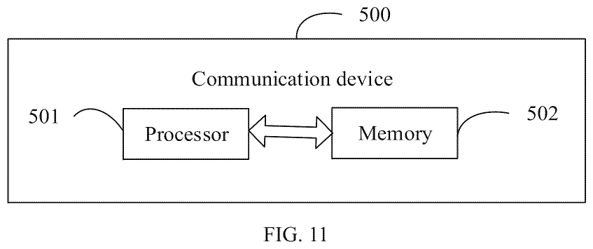

As shown in FIG. 11, an embodiment of this application further provides a communication device 500, including a processor 501 and a memory 502, and the memory 502 stores a program or instructions capable of being run on the processor 501. For example, in a case that the communication device 500 is a terminal, when the program or the instructions are executed by the processor 501, the steps of the foregoing embodiment of the information sending method are implemented, and a same technical effect can be achieved. In a case that the communication device 500 is a network side device, when the program or the instructions are executed by the processor 501, the steps of the foregoing embodiment of the information receiving method are implemented, and a same technical effect can be achieved. To avoid repetition, details are not described herein again.

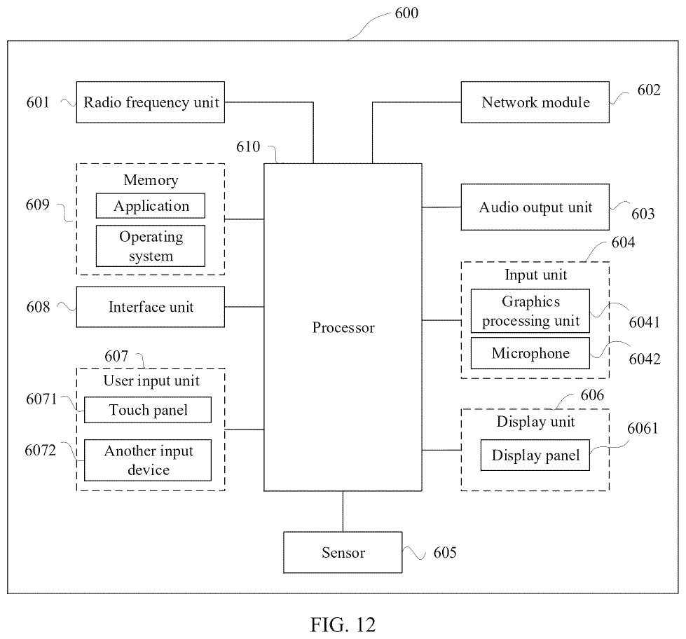

An embodiment of this application further provides a terminal, including a processor and a communication interface. The communication interface is configured to send first indication information to a network side device, where the first indication information is used to request an address of a server, the first indication information is carried in a first message, and the first message is used for at least one of the following: establishing a protocol data unit PDU session; modifying the PDU session; and registration. The terminal embodiment corresponds to the embodiment of the information sending method, each implementation process and implementation of the embodiment of the information sending method can be applied to the terminal embodiment, and a same technical effect can be achieved. FIG. 12 is a schematic diagram of a hardware structure of a terminal according to an embodiment of this application.

The terminal 600 includes but is not limited to at least a part of components such as a radio frequency unit 601, a network module 602, an audio output unit 603, an input unit 604, a sensor 605, a display unit 606, a user input unit 607, an interface unit 608, a memory 609, and a processor 610.

A person skilled in the art can understand that the terminal 600 may further include a power supply (such as a battery) that supplies power to each component. The power supply may be logically connected to the processor 610 by using a power supply management system, to implement functions such as charging and discharging management, and power consumption management by using the power supply management system. The terminal structure shown in FIG. 12 constitutes no limitation on the terminal, and the terminal may include more or fewer components than those shown in the figure, or combine some components, or have different component arrangements. Details are not described herein.

It should be understood that in this embodiment of this application, the input unit 604 may include a Graphics Processing Unit (GPU) 6041 and a microphone 6042. The graphics processing unit 6041 processes image data of a static picture or a video obtained by an image capture apparatus (for example, a camera) in a video capture mode or an image capture mode. The display unit 606 may include a display panel 6061, and the display panel 6061 may be configured in a form of a liquid crystal display, an organic light-emitting diode, or the like. The user input unit 607 includes at least one of a touch panel 6071 and another input device 6072. The touch panel 6071 is also referred to as a touchscreen. The touch panel 6071 may include two parts: a touch detection apparatus and a touch controller. The another input device 6072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 601 may transmit the downlink data to the processor 610 for processing. In addition, the radio frequency unit 601 may send uplink data to the network side device. Generally, the radio frequency unit 601 includes but is not limited to an antenna, an amplifier, a transceiver, a coupler, a low noise amplifier, a duplexer, and the like.

The memory 609 may be configured to store a software program or an instruction and various data. The memory 609 may mainly include a first storage area for storing a program or an instruction and a second storage area for storing data. The first storage area may store an operating system, and an application or an instruction required by at least one function (for example, a sound playing function or an image playing function). In addition, the memory 609 may be a volatile memory or a non-volatile memory, or the memory 609 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 609 in this embodiment of this application includes but is not limited to these memories and any memory of another proper type.

The processor 610 may include one or more processing units. In some embodiments, an application processor and a modem processor are integrated into the processor 610. The application processor mainly processes an operating system, a user interface, an application, or the like. The modem processor mainly processes a wireless communication signal, for example, a baseband processor. It may be understood that the modem processor may not be integrated into the processor 610.

The radio frequency unit 601 is configured to:
send first indication information to a network side device, where the first indication information is used to request an address of a server; where
the first indication information is carried in a first message, and the first message is used for at least one of the following:
establishing a protocol data unit PDU session;
modifying the PDU session; and
registration.

In some embodiments, the server includes at least one of the following:
a server that provides an artificial intelligence AI model downloading service;
a server that provides an AI model updating service;
a server that provides a computing power service; and
a server that provides a sensing service.

In some embodiments, in a case that the first message is used for establishing the PDU session, the first indication information is included in at least one of the following:
a PDU session parameter;
a 5G session management SM core network capability information element IE;
an SM PDU data network DN request container IE;
an N1 SM container IE; and
protocol configuration option PCO information.

In some embodiments, in a case that the first message is used for modifying the PDU session, the first indication information is included in at least one of the following:
quality of service QoS requirement information;
a 5GSM core network capability IE;
an SM container IE; and
PCO information.

In some embodiments, in a case that the first message is used for registration, the first indication information is included in at least one of the following:
a user equipment UE mobility management MM core network capability IE;
a 5GS update option IE; and
a UE policy container IE.

In some embodiments, the radio frequency unit 601 is further configured to receive second indication information sent by the network side device, where the second indication information is used to indicate the address of the server.

The processor 610 is configured to establish a communication connection to the server based on the second indication information.

In some embodiments, in a case that the first message is used for establishing the PDU session, the second indication information is included in at least one of the following:
a PDU session establishment accept message;
an N1 SM container IE; and
PCO information.

In some embodiments, in a case that the first message is used for modifying the PDU session, the second indication information is included in at least one of the following:
a PDU session modification accept message;
an N1 SM container IE; and
PCO information.

In some embodiments, the network side device includes a session management function SMF.

In some embodiments, in a case that the first message is used for registration, the second indication information is included in at least one of the following:
a register accept message; and
a UE policy container IE.

In some embodiments, the radio frequency unit 601 is configured to perform at least one of the following:
receiving the register accept message sent by a first AMF, where the register accept message carries the second indication information; and
receiving the UE policy container IE sent by a PCF, where the UE policy container IE carries the second indication information.

In some embodiments, the address of the server includes at least one of the following:
an internet protocol IP address;
a fully qualified domain name FQDN; and
a website.

An embodiment of this application further provides a network side device, including a processor and a communication interface. The communication interface is configured to receive first indication information sent by a terminal, where the first indication information is used to request an address of a server, the first indication information is carried in a first message, and the first message is used for at least one of the following: establishing a protocol data unit PDU session; modifying the PDU session; and registration. This network side device embodiment corresponds to the foregoing embodiment of the information receiving method. Each implementation process and implementation of the foregoing embodiment of the information receiving method may be applicable to this network side device embodiment, and a same technical effect can be achieved.

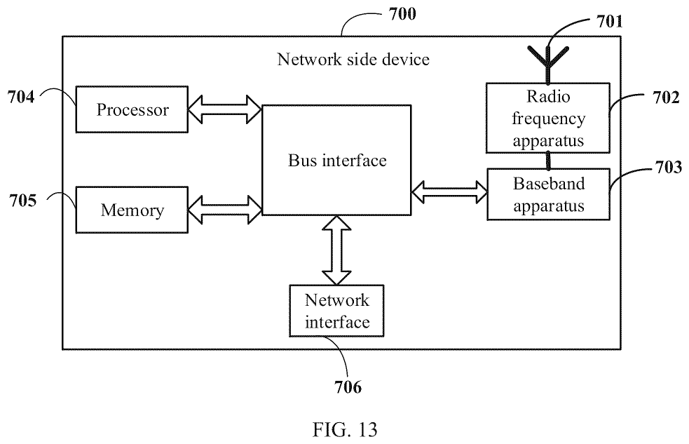

An embodiment of this application further provides a network side device. As shown in FIG. 13, the network side device 700 includes an antenna 701, a radio frequency apparatus 702, a baseband apparatus 703, a processor 704, and a memory 705. The antenna 701 is connected to the radio frequency apparatus 702. In an uplink direction, the radio frequency apparatus 702 receives information through the antenna 701, and sends the received information to the baseband apparatus 703 for processing. In a downlink direction, the baseband apparatus 703 processes information that needs to be sent, and sends processed information to the radio frequency apparatus 702. The radio frequency apparatus 702 processes the received information, and sends processed information through the antenna 701.

In the foregoing embodiment, the method performed by the network side device may be implemented in the baseband apparatus 703. The baseband apparatus 703 includes a baseband processor.

For example, the baseband apparatus 703 may include at least one baseband board. A plurality of chips are disposed on the baseband board. As shown in FIG. 13, one chip is, for example, a baseband processor, and is connected to the memory 705 by using a bus interface, to invoke a program in the memory 705 to perform the operations of the network device shown in the foregoing method embodiment.

The network side device may further include a network interface 706, and the interface is, for example, a common public radio interface (CPRI).

The network side device 700 in this embodiment of the present application further includes an instruction or a program that is stored in the memory 705 and that can be run on the processor 704. The processor 704 invokes the instruction or the program in the memory 705 to perform the method performed by the modules shown in FIG. 10, and a same technical effect is achieved. To avoid repetition, details are not described herein again.

An embodiment of this application further provides a readable storage medium, where the readable storage medium stores a program or instructions, and when the program or the instructions are executed by a processor, the processes of the foregoing information sending method or the information receiving method are implemented and a same technical effect can be achieved. To avoid repetition, details are not described herein again.

The processor is a processor in the terminal in the foregoing embodiments. The readable storage medium may be non-volatile, or may be non-transient. The readable storage medium may include a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or instructions to implement the processes of the foregoing embodiment of the information sending method or the information receiving method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement the processes of the foregoing embodiment of the information sending method or the information receiving method, and a same technical effect can be achieved. To avoid repetition, details are not described herein again.

An embodiment of this application further provides an information receiving/sending system, including a terminal and a network side device, where the terminal may be configured to perform the steps of the foregoing information sending method, and the network side device may be configured to perform the steps of the foregoing information receiving method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the related art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. An information sending method, comprising:
sending, by a terminal, first indication information to a network side device, wherein the first indication information is used to request an address of a server,
wherein the first indication information is carried in a first message, and the first message is used for at least one of the following:
establishing a protocol data unit (PDU) session;
modifying the PDU session; or
registration.

2. The information sending method according to claim 1, wherein the server comprises at least one of the following:
a server that provides an artificial intelligence (AI) model downloading service;
a server that provides an AI model updating service;
a server that provides a computing power service; or
a server that provides a sensing service.

3. The information sending method according to claim 1, wherein when the first message is used for establishing the PDU session, the first indication information is comprised in at least one of the following:
a PDU session parameter;
a 5G session management (SM) core network capability information element (IE);
an SM PDU data network (DN) request container IE;
an N1 SM container IE; or
protocol configuration option (PCO) information.

4. The information sending method according to claim 1, wherein when the first message is used for modifying the PDU session, the first indication information is comprised in at least one of the following:
quality of service (QoS) requirement information;
a 5G session management (SM) core network capability information element (IE);
an SM container IE; or
protocol configuration option (PCO) information.

5. The information sending method according to claim 1, wherein when the first message is used for registration, the first indication information is comprised in at least one of the following:
a user equipment (UE) mobility management (MM) core network capability information element (IE);
a 5GS update option IE; or
a UE policy container IE.

6. The information sending method according to claim 1, further comprising:
receiving, by the terminal, second indication information sent by the network side device, wherein the second indication information is used to indicate the address of the server; and
establishing, by the terminal, a communication connection to the server based on the second indication information.

7. The information sending method according to claim 6, wherein when the first message is used for establishing the PDU session, the second indication information is comprised in at least one of the following:
a PDU session establishment accept message;
an N1 session management (SM) container information element (IE); or
protocol configuration option (PCO) information.

8. The information sending method according to claim 6, wherein when the first message is used for modifying the PDU session, the second indication information is comprised in at least one of the following:
a PDU session modification accept message;
the N1 SM container IE; or
the PCO information.

9. The information sending method according to claim 7, wherein the network side device comprises a session management function (SMF).

10. The information sending method according to claim 6, wherein when the first message is used for registration, the second indication information is comprised in at least one second the following:
a register accept message; or
a user equipment (UE) policy container information element (IE).

11. The information sending method according to claim 10, wherein the receiving, by the terminal, second indication information sent by the network side device comprises:
receiving, by the terminal, the register accept message sent by a first Access and Mobility Management Function (AMF), wherein the register accept message carries the second indication information; and
receiving, by the terminal, the UE policy container IE sent by a Policy Control Function (PCF), wherein the UE policy container IE carries the second indication information.

12. The information sending method according to claim 1, wherein the address of the server comprises at least one of the following:
an internet protocol (IP) address;
a fully qualified domain name (FQDN); or
a website.

13. An information receiving method, comprising:
receiving, by a network side device, first indication information sent by a terminal, wherein the first indication information is used to request an address of a server,
wherein the first indication information is carried in a first message, and the first message is used for at least one of the following:
establishing a protocol data unit (PDU) session;
modifying the PDU session; or
registration.

14. The information receiving method according to claim 13, wherein the server comprises at least one of the following:
a server that provides an artificial intelligence (AI) model downloading service;
a server that provides an AI model updating service;
a server that provides a computing power service; or
a server that provides a sensing service.

15. The information receiving method according to claim 13, wherein when the first message is used for establishing the PDU session, the first indication information is comprised in at least one of the following:
a PDU session parameter;
a 5G session management (SM) core network capability information element (IE);
an SM PDU data network (DN) request container IE;
an N1 SM container IE; or
protocol configuration option (PCO) information.

16. The information receiving method according to claim 13, wherein when the first message is used for modifying the PDU session, the first indication information is comprised in at least one of the following:
quality of service (QoS) requirement information;
a 5G session management (SM) core network capability IE;
an SM container IE; or
protocol configuration option (PCO) information.

17. The information receiving method according to claim 13, wherein when the first message is used for registration, the first indication information is comprised in at least one of the following:
a user equipment (UE) mobility management (MM) core network capability information element (IE);
a 5GS update option IE; or
a UE policy container IE.

18. The information receiving method according to claim 13, further comprising:
sending, by the network side device, second indication information to the terminal, wherein the second indication information is used to indicate the address of the server.

19. The method according to claim 18, wherein when the first message is used for establishing the PDU session, the second indication information is comprised in at least one of the following:
a PDU session establishment accept message;
an N1 session management (SM) container information element (IE); or
protocol configuration option (PCO) information.

20. A terminal, comprising: a memory storing a computer program; and a processor coupled to the memory and configured to execute the computer program to perform operations comprising:
sending first indication information to a network side device, wherein the first indication information is used to request an address of a server,
wherein the first indication information is carried in a first message, and the first message is used for at least one of the following:
establishing a protocol data unit (PDU) session;
modifying the PDU session; or
registration.
